(19) United States
(12) Patent Application Publication
(10) Pub. No.: US 2013/0160301 A1
(43) Pub. Date: Jun. 27, 2013

(54) SHEAR

(71) Applicant: Hsin-Te HUANG, Taichung (TW)

(72) Inventor: Hsin-Te HUANG, Taichung (TW)

(21) Appl. No.: 13/338,088

(22) Filed: Dec. 27, 2011

(51) Int. Cl. B26B 13/00

(52) U.S. Cl. 30/252

(57) ABSTRACT

The shear of the present invention includes a clipper, an elastic element and a holding portion. A first cutter of the clipper forms a pressing face, and a second cutter of the clipper forms a leaning face corresponding to the pressing face. When the clipper splays to a maximum angle, the pressing face and the leaning face touch each other, and the elastic force is accepted by the leaning face. Because the first cutter and the second cutter are made of a same material and the hardness of the first and the second cutters is the same, the contact faces of the cutters are not abraded after several times touching. Thereby, the shear of the present invention is much more durable.

### BACKGROUND OF THE INVENTION

1. Field of the Invention

The present invention relates to a shear.

2. Description of the Prior Art

A shear is used to scissor element in harder material such as iron or stainless copper. Please refer to FIG. 1, a shear disclosed in prior art includes two cutters 61 disposed pivotally to each other. An end of each of the cutters 61 forms a sharp blade 611, and the other end forms a connecting portion 612. A holding portion 62 is disposed on each connecting portion 612. Ends near the cutters of the two holding portions 62 are disposed pivotally to each other. When the two holding portions 62 are gripped together, the two cutters 61 pivot and overlap to each other to scissor the element. A spring urges the two cutters 61 to keep splaying, so a user can grip and release repeatedly the holding portions 62 to keep scissoring.

However, when the spring releases, the connecting portions 621 of the cutters 61 hit the bodies 621 of the holding portions 62 due to the elastic force. Because the hardness of the cutters 61 and the holding portions 62 is different, one of the cutter 61 and the holding portion 62 tends to be abraded. Thereby, the maximum angle of splaying of the cutters 61 increases, and the arrangement of the cutters 61 is changed. The scissoring force and the accuracy of scissoring decrease, or even the shear becomes unable to scissor.

### SUMMARY OF THE INVENTION

The main object of the present invention is to provide a shear with excellent durability.

To achieve the above and other objects, the shear of the present invention includes a clipper, an elastic element and a holding portion.

The clipper includes a first cutter and a second cutter. Each of the first and the second cutters is in a bending form and includes a blade, a pivot portion and a connecting portion. Each pivot portion is located between the blade and the connecting portion. The pivot portions connect to each other to enable the first and the second cutters to splay apart or join together. When the blades join together, the blades overlap and scissor. The pivot portion of the first cutter has a pressing face, and the pivot portion of the second cutter has a leaning face. When the pressing face touches the leaning face, the first and the second cutters are unable to splay, and the blades overlap and contact each other.

The elastic element enables the first cutter and the second cutter to tend to splay to a maximum angle.

The holding portion includes a first holder and a second holder connecting to each other pivotally. The first and the second holders are able to splay apart or join together. The first holder connects to the first cutter, and the second holder connects to the second cutter. Thus, the holding portion and the clipper splay or join simultaneously.

Thereby, when the first cutter and the second cutter splay to a specific angle, the leaning face and the pressing face touch each other, and the elastic force is accepted by the leaning face. Because the clipper is made of the same material, the hardness of the first and the second cutter is the same. Thus, the leaning face and the pressing face are not abraded after several times touching, and the shear of the present invention has excellent durability.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an illustration showing a shear of prior art;

FIG. 2 and FIG. 3 are illustrations showing a shear of the present invention;

FIG. 4 is a partial breakdown view showing a shear of the present invention;

FIG. 5 is a partial stereogram showing a shear of the present invention;

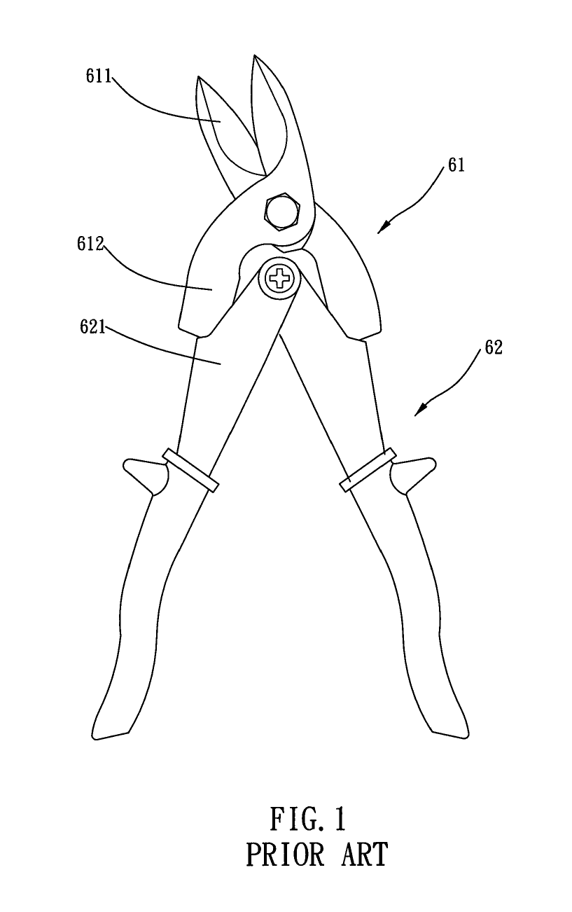

### DETAILED DESCRIPTION OF THE PREFERRED EMBODIMENTS

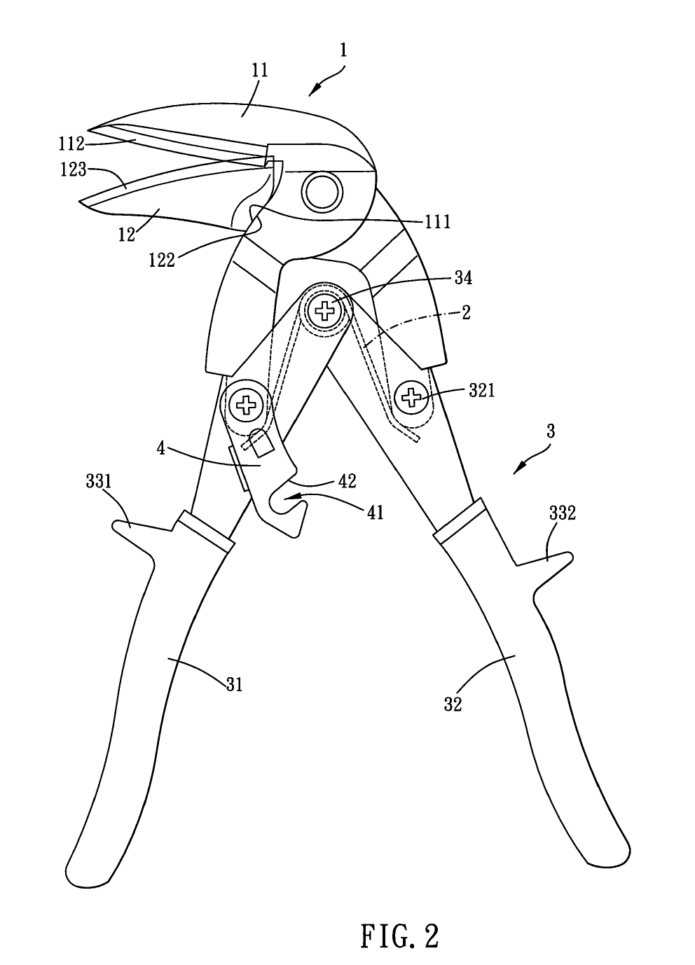

Please refer to FIG. 2 to FIG. 5, the shear of the present invention includes a clipper 1, an elastic element 2, a holding portion 3, and a buckle 4

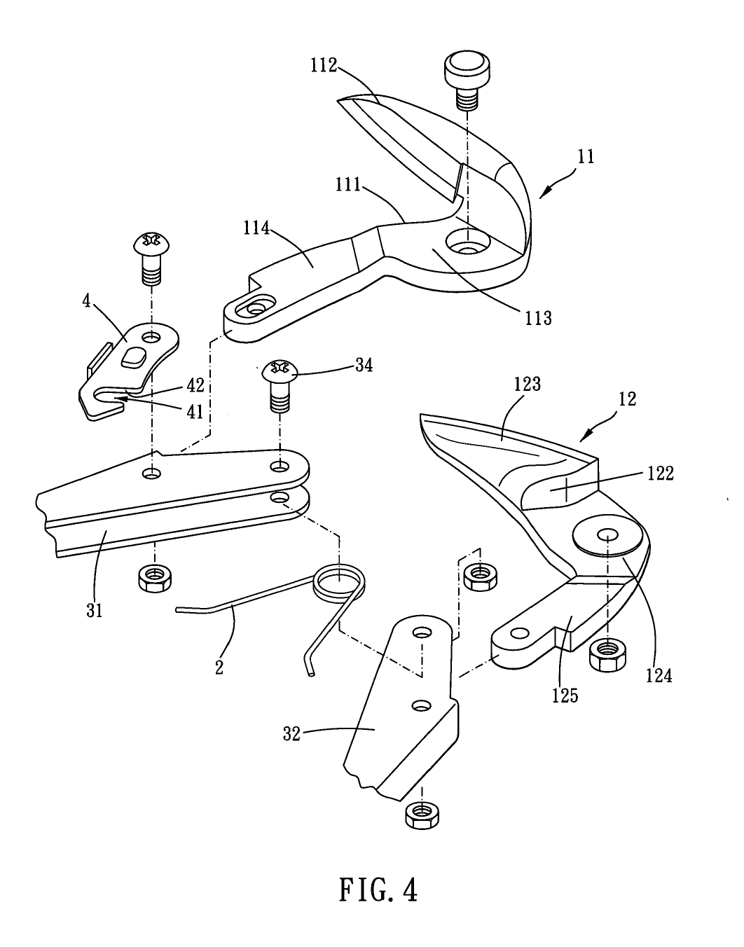

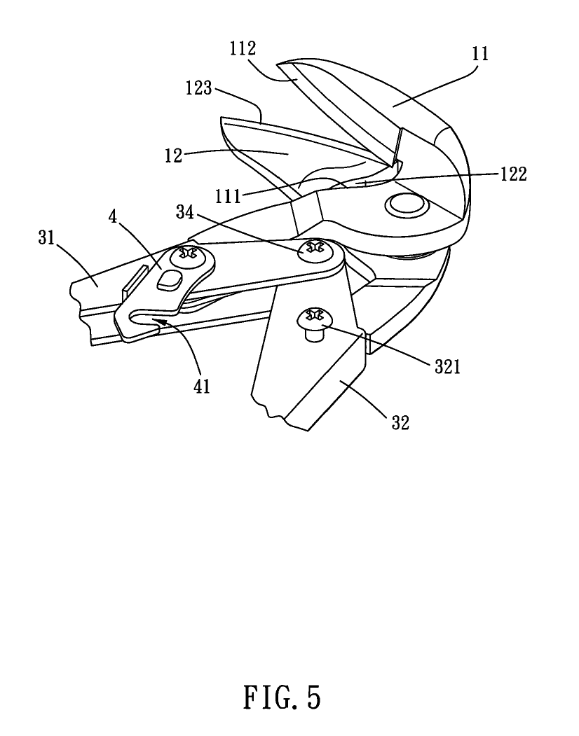

Please refer to FIG. 4 and FIG. 5, the clipper 1 includes a first cutter 11 and a second cutter 12. The first cutter 11 and the second cutter 12 are in a bending form and overlap. Each of the first and the second cutters 11, 12 includes a blade 112,123, a pivot portion 113,124, and a connecting portion 114,125. The pivot portion 113 of the first cutter is located between the blade 112 and the connecting portion 114. The pivot portion 124 is located between the blade 123 and the connecting portion 125. The pivot portions 113,124 connect to each other, so the first cutter 11 and the second cutter 12 are able to splay apart or join together. When the first cutter 11 and the second cutter 12 join together, the blades 112, 123 overlap and scissor.

More specifically, a pressing face 111 is formed on the first cutter 11, and a leaning face 122 is formed on an edge of the blade 123 of the second cutter. When the pressing face 111 and the leaning face 122 touch each other, the first cutter 11 and the second cutter 12 don't splay apart, as shown in FIG. 2 and FIG. 5. When the pressing face 111 and the leaning face 122 touch each other, the first cutter 11 and the second cutter 12 splay to a maximum angle. In other words, the pressing face 111 and the leaning face 122 press against each other to restrict the splay angle of the first cutter 11 and the second cutter 12. Furthermore, to increase the stability of the touching of the pressing face 111 and the leaning face 122, the touching faces of the pressing face 111 and the leaning face 122 can be parallel to each other or corresponding cambered surfaces.

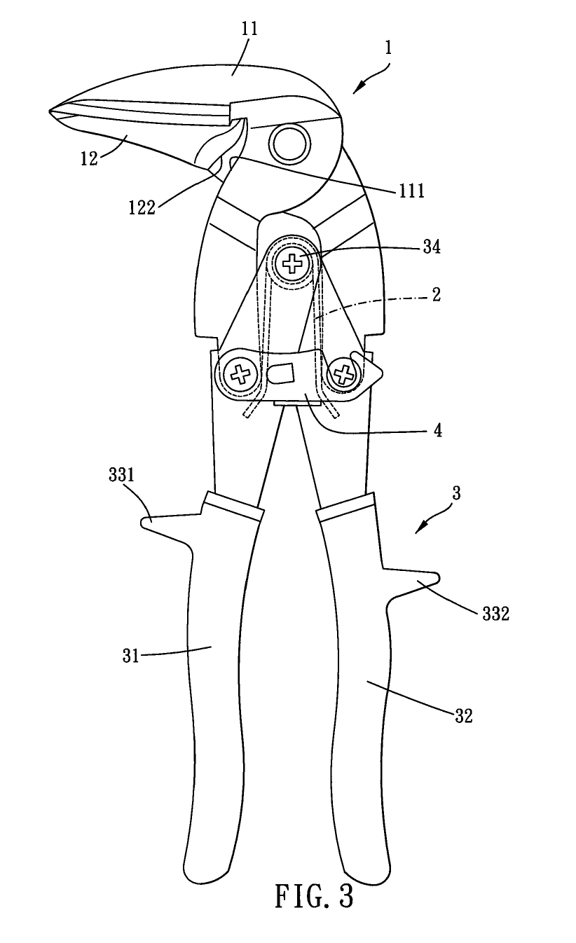

Please refer to FIG. 2 and FIG. 3, the holding portion 3 includes a fixing element 34, a first holder 31 and a second holder 32. In the principal embodiment of the present invention, the fixing element 34 is a threaded bolt. The fixing element 34 inserts in ends of the first holder 31 and the second holder 32, so the first holder 31 and the second holder 32 connect to each other pivotally and are able to splay apart or join together. The first holder 31 connects to the first cutter 11, and the first holder 31 and the first cutter 11 are able to pivot. The second holder 32 connects to the second cutter 12, and the second holder 32 and the second cutter 12 are able to pivot due to fixing by a bolt 321. Thereby, the holding portion 3 and the clipper 1 splay apart or join together simultaneously. More specifically, when the first holder 31 and the second holder 32 join together, the first cutter 11 and the second cutter 12 are joined together. When the first holder 31 and the second holder 32 splay apart, the first cutter 11 and the second cutter 12 are splayed apart.

Besides, to hold more easily, the holding portion 3 also includes two protrusions 331,332. The protrusion 331 extends from the first holder 31 and away from the second holder 32, and the protrusion 332 extends from the second holder 32 and away from the first holder 31. The two protrusions 331,332 extend oppositely and are located on two opposite sides of the holding portion 3 to enable fingers of a user to press against. Moreover, in the principal embodiment of the present invention, a surface of each of the first holder 31 or the second holder 32 has a slip-resistant layer. The slip-resistant layer has high coefficient of friction to reduce slipping when holding the holders.

Please refer to FIG. 4, the elastic element 2 is disposed on the holding portion 3 and is wound on the fixing element 34. One end of the elastic element 2 presses against the first cutter 11, and the other end of the elastic element 2 presses against the second cutter 12. The elastic element 2 urges the first cutter 11 and the second cutter 12 to splay to a maximum angle. More specifically, when the first cutter 11 and the second cutter 12 are joined together, the elastic element 2 is compressed. When the first cutter 11 and the second cutter 12 are released, the elastic element 2 urges the first cutter 11 and the second cutter 12 to splay apart, and the pressing face 111 touches the leaning face 122.

Please refer to FIG. 2 to FIG. 4, the buckle 4 is disposed on the first holder 31 pivotally. An end near the second holder 32 of the buckle 4 has a positioning notch 41, and the outline of the positioning notch 41 corresponds to the bolt 321 to enable the bolt 321 to press against an edge of the positioning notch 41. Thereby, when the first holder 31 and the second holder 32 join together, the buckle 4 is able to be pivoted to enable the bolt 321 to insert to the positioning notch 41, as shown in FIG. 3. The first holder 31 and the second holder 32 are unable to splay due to the buckle 4. If the buckle 4 is pivoted and the positioning notch 41 is away from the bolt 321, the first cutter 11 and the second cutter 12 are able to splay to a maximum angle again due to the elastic force by the elastic element 2, as shown in FIG. 2. To release the buckle 4 more easily, an edge of the positioning notch 41 has an incline face 41. When joining the first holder 31 and the second holder 32 together and urging the bolt 321 to press against the incline face 42, the bolt 321 is moved away from the positioning notch 41 due to the incline of the incline face 42.

In operation of using the shear of the present invention to scissor, moving the buckle 4 to separate the bolt 321 from the positioning notch 41 enables the first holder 31 and the second holder 32 to splay apart or join together. Then, grip the holding portion 3 to scissor. When the holding portion 3 is released, the holding portion 3 tends to splay apart due to the elastic force of the elastic element 2. After working, a user can grip the holding portion 3 to a specific angle and pivot the buckle 4 to enable the bolt 321 to insert to the positioning notch 41, and then the elastic element 2 is unable to splay the first cutter 11 and the second cutter 12 apart. The holding portion 3 is restricted by the buckle 4, as shown in FIG. 3.

The advantages of the shear of the present invention are listed below. When the first cutter and the second cutter splay to a specific angle, the pressing face and the leaning face touch each other and play a role of blocking, and the clipper is unable to splay more. The efficient of blocking is against the elastic force to splay the first cutter and the second cutter apart. Besides, the material of the first cutter and the second cutter is the same, so the first cutter and the second cutter have the same hardness. The touching faces of the pressing face and the leaning face are not abraded anymore. Moreover, the touching faces of the leaning face and the pressing face are larger than the one of prior art, so the partial deformation due to the uneven force is prevented. Thereby, the performance of scissoring is kept stable and is more durable.

What is claimed is:

1. A shear, including:
a clipper, including a first cutter and a second cutter, each of the first and the second cutters being in a bending form and including a blade, a pivot portion, and a connecting portion, each pivot portion being located between the blade and the connecting portion, the pivot portions connecting to each other to enable the first and the second cutters to splay apart or join together, the blades overlapping and scissoring when the blades join together, the pivot portion of the first cutter having a pressing face, an edge of the blade of the second cutter has a leaning face, the first cutter and the second cutter being unable to splay apart and the blades overlapping and contacting each other when the pressing face touches the leaning face;
an elastic element, the elastic element enabling the first cutter and the second cutter to tend to splay to a maximum angle;
a holding portion, including a first holder and a second holder connecting to each other pivotally, the first holder and the second holder being able to splay apart or join together, the first holder connecting to the connecting portion of the first cutter, the second holder connecting to the connecting portion of the second cutter, the holding portion and the clipper splay or join simultaneously.

2. The shear of claim 1, wherein an end of the elastic element leans against the first cutter, the other end of the elastic element leans against the second cutter.

3. The shear of claim 2, wherein the holding portion includes two protrusions, one of the protrusions extends from the first holder and away from the second holder, the other protrusion extends from the second holder and away from the first holder.

4. The shear of claim 3, including a buckle, the buckle being disposed on the first holder and being able to pivot relatively to the first holder, a positioning notch being formed on the buckle, a bolt being disposed on the second holder, the first holder and the second holder being unable to splay apart when the bolt presses against an edge of the positioning notch.

5. The shear of the claim 4, wherein the buckle has an incline face at the edge of the positioning notch, the incline face enables the bolt to press against and urges the bolt to leave from the positioning notch.

6. The shear of claim 5, wherein the second holder and the second cutter connect to each other due to the insertion of the bolt.

7. The shear of claim 6, wherein a slip-resistant layer is disposed on a surface of each of the first holder and the second holder.

8. The shear of claim 7, wherein the holding portion includes a fixing element to connect the first holder and the second holder together, the elastic element is wound on the fixing element.
